(19) United States
(12) Patent Application Publication
(10) Pub. No.: US 2018/0313706 A1
(43) Pub. Date: Nov. 1, 2018

(54) WIND SPEED MEASUREMENT APPARATUS

(71) Applicants: DONGGUK UNIVERSITY INDUSTRY-ACADEMIC COOPERATION FOUNDATION, Seoul (KR); YOUNGKWANG MACHINE CO., LTD., Gyeongju-si, Gyeongsangbuk-do (KR)

(72) Inventors: Myungho SONG, Seoul (KR); Sae Bom PARK, Anyang-si, Gyeonggi-do (KR); Yeon Jin AN, Hwaseong-si, Gyeonggi-do (KR); Chul Koo HEO, Ulsan (KR); Seon-Jae LEE, Yangsan-si, Gyeongsangnam-do (KR)

(73) Assignees: DONGGUK UNIVERSITY INDUSTRY-ACADEMIC COOPERATION FOUNDATION, Seoul (KR); YOUNGKWANG MACHINE CO., LTD., Gyeongju-si, Gyeongsangbuk-do (KR)

(21) Appl. No.: 15/756,068

(22) PCT Filed: Aug. 26, 2016
(86) PCT No.: PCT/KR2016/009549

§ 371 Date: Feb. 28, 2018

(30) Foreign Application Priority Data
Aug. 28, 2015 (KR) 10-2015-0121425

(51) Int. Cl. G01L 5/00; G01L 1/20

(52) U.S. Cl. CPC G01L 5/00; G01L 1/20

(57) ABSTRACT

A wind speed measurement apparatus includes a rotating shaft, at least one blades provided radially around the rotating shaft and rotated by force of wind exerted on the at least one blade, and a frame provided at one side of the at least one blade and having a space therein such that the rotating shaft penetrates through the space.

### TECHNICAL FIELD

The present disclosure relates to an apparatus for measuring a wind speed, and more particularly, to a wind speed measurement apparatus that is included in a wind power generator and measures a wind speed transmitted to the wind power generator.

### BACKGROUND ART

Generally, a wind power generator is an apparatus that converts energy obtained through wind to rotational kinetic energy and then to electric energy, and is used as an environmental-friendly and relatively economical alternative energy source.

The wind power generator is configured such that blades formed around a hub are rotated by wind, and such rotation is converted into electric energy in relation to the generator. In other words, air particles collide with the blades while moving, and the blades are rotated by force of the collided air. However, since a wind speed applied to the rotating blades is not constant, a device for controlling the pitch of the blades may be further provided to adjust efficiency of the generator. Such a control device adjusts the number of revolutions of the blades to be suitable for the efficiency of the generator, and at this time, a wind speed measurement apparatus is provided to measure a wind speed to determine the suitable number of revolutions. In other words, the pitch of the blades is adjusted based on the wind speed measured by the wind speed measurement apparatus, and the control device adjusts rotatory power of the blades when the wind speed exceeds a designated value.

KR 10-2009-0105308 discloses a technology related to a general wind speed measurement apparatus provided to measure a wind speed of a wind power generator as described above. A wind speed measurement apparatus using ultrasonic waves used by a general wind power generator has a certain distance from blades, and thus there may be an error in obtaining data of a wind speed and thrust given to the blades. Also, due to a structure including complicated and various sensors, installation is complicated and malfunction occurs.

Also, such a wind speed measurement apparatus using ultrasonic waves is sensitive to a temperature and humidity and thus is restricted by an external environment.

### DETAILED DESCRIPTION OF THE INVENTION

### Technical Problem

Provided is a wind speed measurement apparatus that not only outputs accurate data by directly identifying thrust exerted on blades, but also measures a wind speed with a simple structure, and is not restricted by an external environment.

### Technical Solution

According to an aspect of an embodiment, a wind speed measurement apparatus for measuring a wind speed of a wind power generator that includes a rotating shaft, at least one blades provided radially around the rotating shaft and rotated by force of wind exerted on the at least one blade, and a frame provided at one side of the at least one blade and having a space therein such that the rotating shaft penetrates through the space, wherein the rotating shaft includes a fixed shaft fixed at one side of the frame and a movable shaft having one side connected to the fixed shaft by a sliding coupling and the other side connected to the at least one blade so as to slidingly move by the force of wind exerted on the at least one blade, the wind speed measurement apparatus includes: a pressure plate formed on an outer circumference of the movable shaft and coupled to the movable shaft via a bearing as a medium; a load sensor provided between the frame and the pressure plate and measuring pressure applied by the pressure plate; a revolution counter measuring the number of revolutions of the fixed shaft; and a calculator electrically connected to the load sensor and the revolution counter to calculate a wind speed based on the pressure and the number of revolutions.

A through hole may be formed to penetrate through the rotating shaft inside the frame and a load sensor supporter may be provided to be supported by an inner side of the frame, wherein the load sensor may be provided between the load sensor supporter and the pressure plate to measure the pressure applied by the pressure plate.

The load sensor may be configured as a load cell to measure the pressure applied by the pressure plate.

A plurality of the load sensors may be formed in a radial direction around the rotating shaft and may be spaced apart from each other at regular intervals.

### Advantageous Effects of the Invention

According to a wind speed measurement apparatus of the present disclosure, a load sensor may be provided to directly detect thrust exerted on blades and measure a wind speed through the thrust, thereby obtaining accurate data.

Also, the wind speed measurement apparatus is integrated with a rotating shaft inside a frame in which a generator or the like is mounted, and thus is not affected by an external environment and is not restricted by an installation place. In addition, the wind speed measurement apparatus has a simple structure, and thus may malfunction less, may be easily installed, and may be manufactured at low costs.

Also, the wind speed measurement apparatus may include a plurality of load sensors to distributively measure the thrust exerted on the blades, and accordingly, the life of the wind speed measurement apparatus may be increased by distributing the functions of the load sensors.

### DESCRIPTION OF THE DRAWINGS

FIG. 1 is a cross-sectional view schematically illustrating a wind speed measurement apparatus according to an embodiment of the present disclosure.

FIG. 2 is a front view of an installation location of a load sensor of the wind speed measurement apparatus of FIG. 1.

FIG. 3 is a flow diagram schematically illustrating wind speed measuring processes of the wind speed measurement apparatus of FIG. 1.

FIG. 4 is graph for describing an example of calculating a wind speed by a calculator of the wind speed measurement apparatus of FIG. 1.

FIG. 5 is a cross-sectional view schematically illustrating a wind speed measurement apparatus according to another embodiment of the present disclosure.

### BEST MODE

Hereinafter, one or more exemplary embodiments of the present disclosure will be described more fully with reference to the accompanying drawings. The terms or words used herein must not be interpreted in their common or dictionary definitions, but must be interpreted in the meanings and concept corresponding to the aspect of the present disclosure, based on the principle that the inventor(s) can suitably define the concept of terms in order to describe the invention in the best manner.

Accordingly, the embodiments and drawings described herein are only preferred examples, and do not represent the technical aspects of the present disclosure. Thus, one of ordinary skill in the art understands that the invention may be embodied in many different forms.

Hereinafter, one or more embodiments of the present disclosure are described in detail with reference to the accompanying drawings.

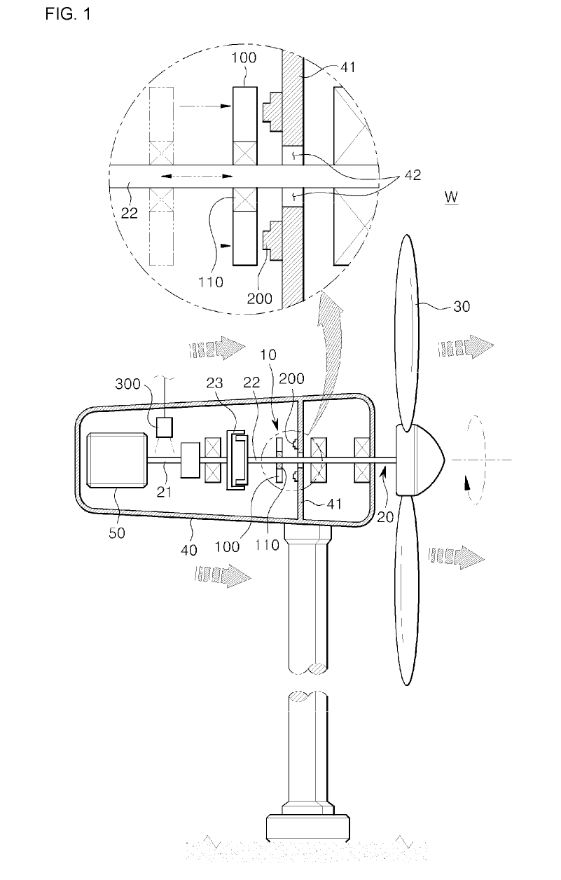

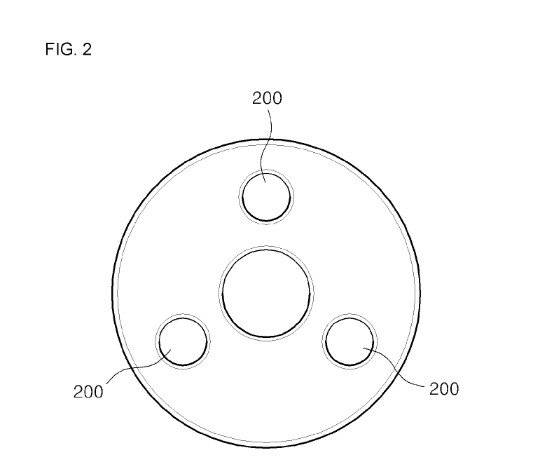

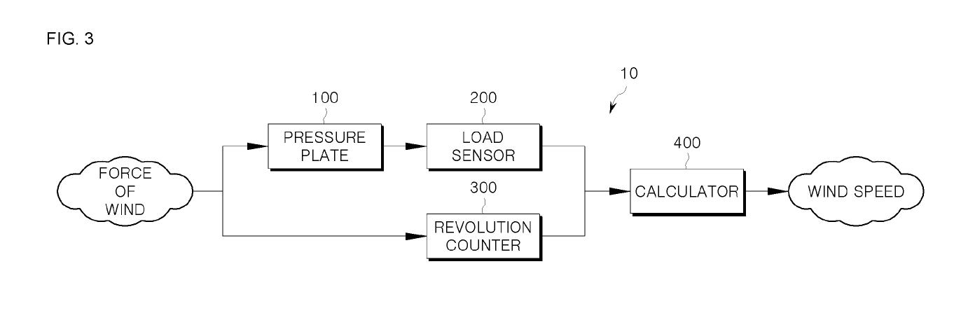

Referring to FIGS. 1 through 4, a wind speed measurement apparatus 10 according to an embodiment of the present disclosure is included in a wind power generator W to measure a wind speed of the wind power generator W, wherein the wind power generator W includes a rotating shaft 20, a blade 30, and a frame 40. The wind power generator W includes at least one blade 30 provided radially around the rotating shaft 20, wherein the at least one blade 30 is rotated around the rotating shaft 20 under the force of wind. The frame 40 is provided at the front (the left side of FIG. 1), i.e., one side of the blade 30, and has a space therein. Also, the rotating shaft 20 may penetrated into the frame 40. Here, the rotating shaft 20 includes a fixed shaft 21 and a movable shaft 22. The fixed shaft 21 is rotatably coupled to the frame 40, and the movable shaft 22 has one side connected to the fixed shaft 21 through a sliding coupling 23 and the other side connected to the blade 30. Accordingly, the movable shaft 22 may slidingly move in correspondence with the force of wind exerted on the blade 30. Here, the frame 40 shown in FIGS. 1 through 4 illustrates a schematic configuration of the wind power generator W, wherein a generator and a compressor 50 may be connected inside and outside the frame 40 and other components required in the wind power generator W may be additionally provided. However, since such additional components are irrelevant to the gist of the present disclosure, details thereof are not provided herein.

Meanwhile, the frame 40 may further include a load sensor supporter 41. The load sensor supporter 41 is provided inside the frame 40. Also, the load sensor supporter 41 includes, at the center, a through hole 42 through which the rotating shaft 20 penetrates, and is supported by an inner side of the frame 40.

The wind speed measurement apparatus 10 included in the wind power generator W and measuring a speed of wind includes a pressure plate 100, a load sensor 200, a revolution counter 300, and a calculator 400.

The pressure plate 100 is coupled to the movable shaft 22 via a bearing 110 as a medium. In other words, the pressure plate 100 may be formed on an outer circumference of the movable shaft located inside the frame 40, and coupled to the movable shaft 22 via the bearing 110 as a medium. Here, the bearing 110 prevents the pressure plate 100 coupled to the movable shaft 22 from being rotated together with the movable shaft 22. In other words, the pressure plate 100 is not rotated with the movable shaft 22, but is slidingly moved together when the movable shaft 22 slidingly moves under the force of wind.

The load sensor 200 is used to measure thrust of wind, and is provided between the frame 40 and the pressure plate 100 and supported by the frame 40. In detail, the load sensor 200 may be provided between the load sensor supporter 41 and the pressure plate 100, and may be fixed by being supported by the load sensor supporter 41. However, the load sensor 200 is not limited to being supported by the frame 40 and may alternatively be supported by a bearing or another supporting device.

The load sensor 200 may be configured as a load cell, i.e., a sensor measuring force. However, the load sensor 200 is not limited to a load cell and may be a force sensor having another configuration capable of measuring pressure. In other words, the pressure plate 100 may slidingly move by the thrust of wind exerted on the blade 30 to pressurize the load sensor 200, and the load sensor 200 may determine the thrust of wind by measuring the pressure applied to the load sensor 200. The pressure plate 100 may slidingly move towards the blade 30 (the right side of FIG. 1) by wind, and pressurize the load sensor 200 provided at one side. Accordingly, the load sensor 200 directly identifies the pressure applied by the force of wind, and thus compared with a case where a load transmitting mechanism is provided between the load sensor 200 and the blade 30, accurate data may be obtained by reducing an error caused by friction or the like.

Also, a plurality of the load sensors 200 may be provided in a radial direction based on the rotating shaft 20. Here, the plurality of load sensors 200 may be spaced apart from each other at regular intervals. The plurality of load sensors 200 may be provided to calculate the total thrust by adding the force measured by each of the plurality of load sensors 200, thereby determining a wind speed. Also, since the thrust is distributively measured by providing the plurality of load sensors 200, the total thrust may be accurately measured even when the thrust is unevenly distributed in a circumferential direction.

The revolution counter 300 is provided at one side of the rotating shaft 20 to measure a rotating speed of the rotating shaft 20. The revolution counter 300 may be provided at the fixed shaft 21 of the rotating shaft, and may be a tachometer or the like.

Accordingly, the calculator 400 calculates the wind speed based on the pressure measured by the load sensor 200 and the number of revolutions measured by the revolution counter 300.

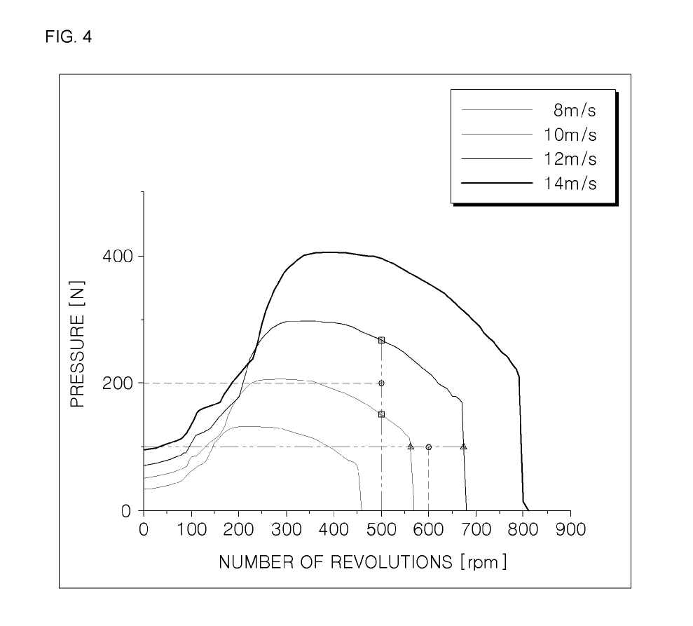

As shown in a graph of FIG. 4, the wind speed may be calculated based on the number of revolutions of the rotating shaft 20 rotated through the blade 30, and the pressure, i.e., the total thrust, measured by the load sensor 200. For example, a wind speed when the number of revolutions is 500 rpm and the pressure is 200 N may be calculated by using an interpolation method from pressure values at two points (indicated by “□” in FIG. 4) where the number of revolutions is 500 rpm and the wind speeds are respectively 10 m/s and 12 m/s. Similarly, a wind speed when the number of revolutions is 600 rpm and the pressure is 100 N may be calculated by using an interpolation method from the numbers of revolutions at two points (indicated by “Δ” in FIG. 4) where the pressure is 100 N and the wind speeds are respectively 10 m/s and 12 m/s. In other words, a method of calculating a wind speed from the number of revolutions and pressure, i.e., total thrust, may be performed differently based on a range of a combination of the number of revolutions and the pressure.

According to the wind speed measurement apparatus 10 of the present disclosure, the load sensor 200 may be provided to directly detect thrust exerted on the blade 30 and measure a wind speed through the thrust, thereby obtaining accurate data.

Also, the wind speed measurement apparatus 10 is provided inside the frame 40, and thus is not affected by an external environment and is not restricted by an installation place. In addition, the wind speed measurement apparatus 10 has a simple structure, and thus may malfunction less, may be easily installed, and may be manufactured at low costs.

Also, the plurality of load sensors 200 are provided to distributively measure the thrust exerted on the blade 30, and accordingly, the total thrust may be accurately measured even when the thrust is unevenly distributed in a circumferential direction.

It should be understood that embodiments described herein should be considered in a descriptive sense only and not for purposes of limitation. Descriptions of features or aspects within each embodiment should typically be considered as available for other similar features or aspects in other embodiments.

### MODE OF THE INVENTION

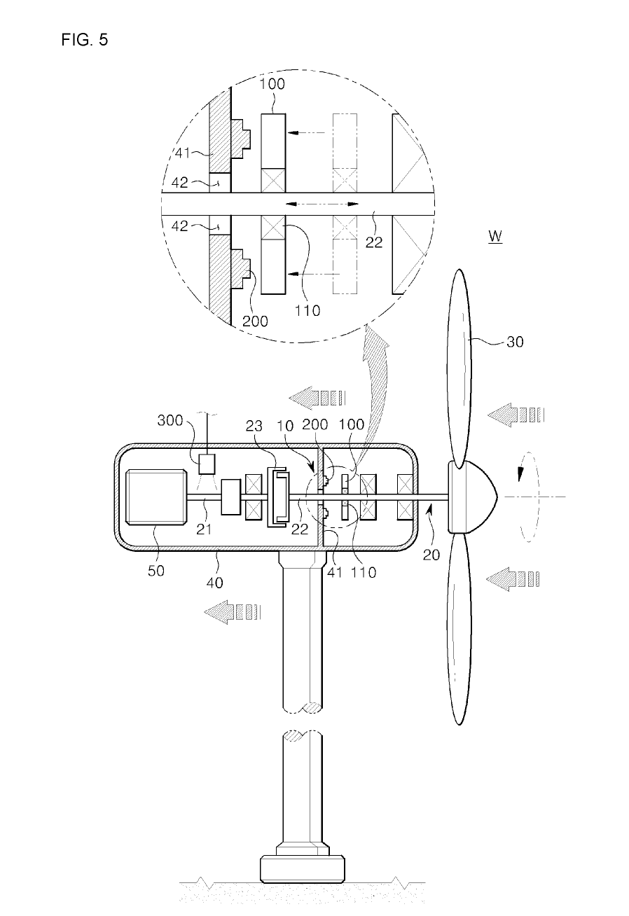

Hereinafter, the wind speed measurement apparatus 10 according to another embodiment of the present disclosure will be described with reference to FIG. 5. FIG. 5 is a cross-sectional view schematically illustrating the wind speed measurement apparatus 10 according to the other embodiment of the present disclosure. Here, since reference numerals that are same as those in FIGS. 1 through 3 denote the same elements having the same structures and functions, repetitive descriptions are not provided.

The wind speed measurement apparatus 10 according to the other embodiment includes the wind power generator W that includes the rotating shaft 20, the blade 30, and the frame 40. Here, the frame 40 is provided at the back (the left side of FIG. 5), i.e., one side of the blade 30. Also, the frame 40 has a space therein, and may further include the load sensor supporter 41 therein. The rotating shaft 20 may penetrate into the frame 40, and includes the fixed shaft 21 and the movable shaft 22.

The pressure plate 100 is slidingly moved together when the movable shaft 22 slidingly moves under the force of wind exerted on the blade 30, and may pressurize the load sensor 200 through such sliding movement. Accordingly, the load sensor 200 may measure the thrust using the pressure applied by the pressure plate 100. In other words, the pressure plate 100 is slidingly moved backwards (the left side of FIG. 5) of the blade 30 by wind, and may pressurize the load sensor 200 provided at one side.

According to the wind speed measurement apparatus 10 of the present disclosure, the load sensor 200 may be provided to directly detect thrust exerted on the blade 30 and measure a wind speed through the thrust, thereby obtaining accurate data.

Also, the wind speed measurement apparatus 10 is provided inside the frame 40, and thus is not affected by an external environment and is not restricted by an installation place. In addition, the wind speed measurement apparatus 10 has a simple structure, and thus may malfunction less, may be easily installed, and may be manufactured at low costs.

Also, the plurality of load sensors 200 are provided to distributively measure the thrust exerted on the blade 30, and accordingly, the total thrust may be accurately measured even when the thrust is unevenly distributed in a circumferential direction.

It should be understood that embodiments described herein should be considered in a descriptive sense only and not for purposes of limitation. Descriptions of features or aspects within each embodiment should typically be considered as available for other similar features or aspects in other embodiments.

=Explanation of Reference Numerals=

| | |
|---|---|
| 10: Wind Speed Measurement Apparatus | 20: Rotating Shaft |
| 21: Fixed Shaft | 22: Movable Shaft |
| 23: Sliding Coupling | 30: Blade |
| 40: Frame | 41: Load Sensor Supporter |
| 42: Through Hole | 50: Compressor |
| 100: Pressure Plate | 110: Bearing |
| 200: Load Sensor | 300: Revolution Counter |
| 400: Calculator | W: Wind Power Generator |

1. A wind speed measurement apparatus for measuring a wind speed of a wind power generator that comprises a rotating shaft, at least one blades provided radially around the rotating shaft and rotated by force of wind exerted on the at least one blade, and a frame provided at one side of the at least one blade and having a space therein such that the rotating shaft penetrates through the space,
wherein the rotating shaft comprises a fixed shaft fixed at one side of the frame and a movable shaft having one side connected to the fixed shaft by a sliding coupling and the other side connected to the at least one blade so as to slidingly move by the force of wind exerted on the at least one blade,
the wind speed measurement apparatus comprising:
a pressure plate formed on an outer circumference of the movable shaft and coupled to the movable shaft via a bearing as a medium;
a load sensor provided between the frame and the pressure plate and measuring pressure applied by the pressure plate;
a revolution counter measuring the number of revolutions of the fixed shaft; and
a calculator electrically connected to the load sensor and the revolution counter to calculate a wind speed based on the pressure and the number of revolutions.

2. The wind speed measurement apparatus of claim 1, wherein a through hole is formed to penetrate through the rotating shaft inside the frame and a load sensor supporter is provided to be supported by an inner side of the frame,
wherein the load sensor is provided between the load sensor supporter and the pressure plate to measure the pressure applied by the pressure plate.

3. The wind speed measurement apparatus of claim 1, wherein the load sensor is configured as a load cell to measure the pressure applied by the pressure plate.

4. The wind speed measurement apparatus of claim 1, wherein a plurality of the load sensors are formed in a radial direction around the rotating shaft and are spaced apart from each other at regular intervals.

5. The wind speed measurement apparatus of claim 2, wherein a plurality of the load sensors are formed in a radial direction around the rotating shaft and are spaced apart from each other at regular intervals.

6. The wind speed measurement apparatus of claim 3, wherein a plurality of the load sensors are formed in a radial direction around the rotating shaft and are spaced apart from each other at regular intervals.
